(19) United States
(12) Patent Application Publication
(10) Pub. No.: US 2015/0293373 A1
(43) Pub. Date: Oct. 15, 2015

(54) GLASSES AND MANUFACTURING METHOD THEREOF

(71) Applicant: BOE TECHNOLOGY GROUP CO, LTD., Beijing (CN)

(72) Inventors: Wenbo Li, Beijing (CN); Li Zhou, Beijing (CN)

(21) Appl. No.: 14/403,689

(22) PCT Filed: Mar. 25, 2014
(86) PCT No.: PCT/CN2014/074030

§ 371 Date: Nov. 25, 2014

(30) Foreign Application Priority Data
Oct. 18, 2013 (CN) 201310492095.9

(51) Int. Cl. G02C 5/00; G02C 13/00; G02C 7/12; G02B 27/26

(52) U.S. Cl. CPC G02C 5/008; G02B 27/26; G02C 13/001; G02C 7/12

(57) ABSTRACT

The present invention provides glasses and a manufacturing method thereof, and belongs to the field of display technology. The glasses of the present invention comprises lenses, and further comprises a first frame made of a paper material, the first frame comprises legs and a lens frame which are integrally formed, the lens frame is provided with lens holes for viewing, and the lenses are provided at the lens holes.

### FIELD OF THE INVENTION

The present invention relates to the field of display technology, and particularly to glasses and a manufacturing method thereof.

### BACKGROUND OF THE INVENTION

Glasses are composed of a frame and lenses. Different kinds of lenses grant glasses various functions such as a function of improving and correcting vision, a function of changing brightness of light for eye protection, and a function of decoration for aesthetic purposes. Specially made glasses may be used for viewing 3D stereo images.

A frame of an existing pair of glasses is generally made of a metal or plastic material, and alternatively, the interior of a frame is made of a metal material and the exterior of the frame is made of a plastic material. Thus, the frame needs to be moulded by a specialized mould, and meanwhile, there are special requirements on the cutting process of lenses.

The inventors found that at least following problems exist in the prior art: the current manufacturing process of glasses is complicated and production cost is high.

### SUMMARY OF THE INVENTION

In view of the above problems, the technical problem to be solved by the present invention includes providing glasses with simple manufacturing process and low cost.

The technical solutions used to solve the technical problem of the present invention include glasses comprising lenses, wherein, the glasses further comprise a first frame made of a paper material, the first frame comprises legs and a lens frame which are formed integrally, the lens frame is provided with lens holes for viewing, and the lenses are provided at the lens holes.

For the glasses according to the present invention, the frame thereof is made of a paper material, so the legs and the lens frame thereof are light in weight and less likely to be fractured, thus prolonging its service life; moreover, due to its simple manufacturing process in which the conventional frame moulding process is omitted, the product price is low and the glasses are easy to carry.

Preferably, the glasses further comprise a second frame, which has the same material and shape as the first frame and is bonded to the first frame; and

the lenses are sandwiched between the first frame and the second frame.

Preferably, the paper material is made by adding starch slurry, gum, rosin, ceramic powder, calcium carbonate and/or white clay into wood pulp.

Preferably, on surfaces of the first frame or the bonded first and second frames, a film layer formed of polyethylene, polypropylene, polyester or aluminum is provided, or a wax film layer is coated.

Preferably, on an inner surface of the first frame or the bonded first and second frames, a coating in black color or other dark color is provided.

Preferably, the lenses are polarizing lenses which are used for viewing 3D stereo images.

Preferably, holes or slots are provided in the legs of the first frame or the bonded first and second frames.

The technical solutions used to solve the technical problem of the present invention further include a manufacturing method of glasses, which comprises steps of:

selecting a paper material, and integrally forming a first frame including legs, a lens frame and lens holes by cutting; and

providing lenses at the lens holes.

Preferably, the step of selecting a paper material, and integrally forming a first frame including legs, a lens frame and lens holes by cutting specifically comprises steps of:

selecting the paper material, and forming the first frame including shapes of the legs and the lens frame by cutting;

forming the lens holes in the lens frame; and

distributing areas for the legs and the lens frame to obtain boundaries between the legs and the lens frame, then folding along the boundaries between the legs and the lens frame to form the legs and the lens frame.

Further preferably, the manufacturing method further comprises steps of: forming a second frame; and bonding the first and second frames to each other.

Further preferably, the step of forming the second frame comprises steps of:

selecting the paper material; and forming the second frame including shapes of legs and a lens frame by cutting, the second frame having the same shape as the first frame;

forming lens holes having the same shape as the lens holes of the first frame in the lens frame of the second frame; and

distributing the same areas for the legs and the lens frame of the second frame as those distributed in the first frame to obtain boundaries between the legs and the lens frame; and

after providing the lenses at the lens holes of the first frame or the second frame, the step of bonding the first and second frames to each other is performed.

Preferably, the manufacturing method further comprises a step of:

on surfaces of the first frame or the bonded first and second frames, forming a film layer formed of polyethylene, polypropylene, polyester or aluminum or forming a wax film layer.

Preferably, the manufacturing method further comprises a step of:

forming a coating in black color or other dark color on an inner surface of the first frame or the bonded first and second frames.

Preferably, the manufacturing method further comprises a step of:

forming polarizing lenses which are used for viewing 3D stereo images.

Preferably, the manufacturing method further comprises a step of:

forming holes or slots in the legs of the first frame or the bonded first and second frames.

### BRIEF DESCRIPTION OF THE DRAWINGS

FIG. 1 is a schematic diagram of a structure of glasses (composed of a first frame) according to Embodiment 1 of the present invention;

FIG. 2 is a schematic diagram of a structure of a second frame of the glasses according to Embodiment 1 of the present invention;

FIG. 3 is a schematic diagram of a structure after the first and second frames of the glasses according to Embodiment 1 of the present invention are bonded to each other;

FIG. 4 is a schematic diagram of a structure of a first frame integrally formed by cutting in Embodiment 2 of the present invention; and

FIGS. 5(a) and 5(b) are schematic diagrams illustrating a manufacturing process of the frame of the glasses according to Embodiment 2 of the present invention.

### REFERENCE NUMERALS

11,12 leg; 12, 22 lens frame; 13, 23 lens hole; 14 lens; 15, 25 boundary

### DETAILED DESCRIPTION OF THE EMBODIMENTS

In order to make a person skilled in the art better understand the technical solutions of the present invention, the present invention will be described in detail below in conjunction with the accompanying drawings and specific implementations.

### Embodiment 1

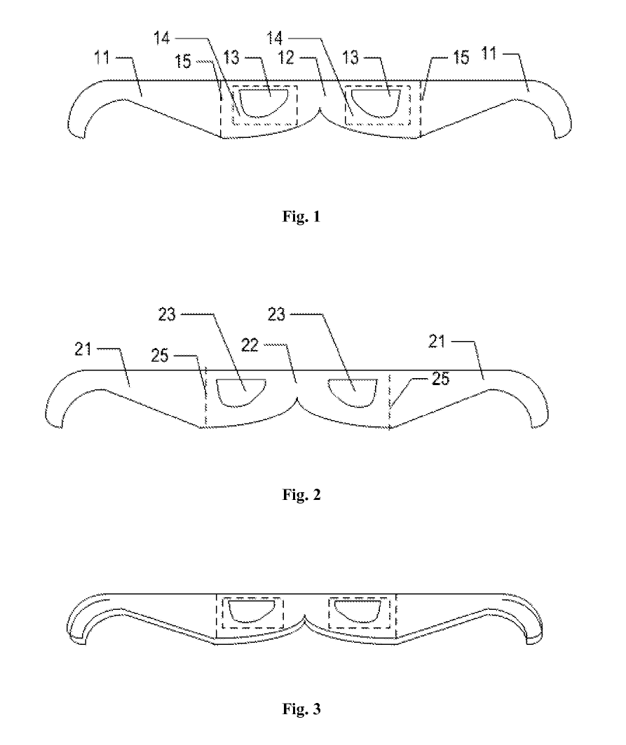

This embodiment provides glasses, which, as shown in FIGS. 1-3, comprises lenses 14 and a first frame made of a paper material. The first frame comprises legs 11 and a lens frame 12 which are integrally formed, the lens frame 12 is provided with lens holes 13 for viewing, and the lenses 14 are provided at the lens holes 13.

It can be understood that, the lens holes 13 are areas for viewing. Generally, there are two lens holes 13 where the lens 14 are provided, and shape and size of the lens hole 13 may be set as required, which are not limited herein.

The lens 14 may have a shape similar to that of the lens hole 13, and alternatively, may have a simple shape such as rectangle, trapezoid, or other regular or irregular shape, as long as the lens 14 can cover the lens hole 13. The lens 14 may be provided at the lens hole 13 in various ways, for example, the rim of the lens 14 may be attached to a region of the lens frame 12 surrounding the lens hole 13 by using an adhesive, and alternatively, the lens 14 may be provided at the lens hole 13 by way of engaging, hinging, thread connecting, riveting or the like.

In this embodiment, the first frame of the glasses is made of a paper material. Since the paper material has soft texture and is easy to cut, the shape of the first frame may be formed manually or by automatic cutting without using a specialized mould to take shape. Thus, the manufacturing process is simple, the cost is low, and the glasses are light in weight, easy to carry and less likely to be fractured.

Preferably, as shown in FIG. 2, the glasses provided by this embodiment may further comprise a second frame which has the same shape and size as the first frame and is bonded to the first frame. The lenses 14 are sandwiched between the first frame and the second frame, and the structure of the bonded first frame and the second frame is shown in FIG. 3.

The second frame is also made of a paper material, and comprises legs 21 and a lens frame 22 which is provided with lens holes 23 for viewing. In this embodiment, the relative position between the first and second frames is not limited, for example, if the lenses 14 are provided at an outer side of the first frame, the second frame may be bonded to the outer side of the first frame, and if the lenses 14 are provided at an inner side of the first frame, the second frame may be bonded to the inner side of the first frame, so that the lenses 14 are sandwiched between the two frames.

It should be noted that, if the lenses 14 are provided at the outer side of the first frame and the second frame is bonded to the inner side of the first frame, or if the second frame is bonded to the outer side of the first frame and the lenses 14 are provided at the outer side of the second frame (i.e., the lenses 14 are provided at the outer side of the two bonded frames, instead of between the two frames); or if the lenses 14 are provided at the inner side of the first frame and the second frame is bonded to the outer side of the first frame, or if the second frame is bonded to the inner side of the first frame and the lenses 14 are provided at the inner side of the second frame (i.e., the lenses 14 are provided at the inner side of the two bonded frames, instead of between the two frames), the resulting structure can also achieve the purpose of the present invention, but appearance of the glasses may be affected to some extent.

There may be various ways to bond the first frame to the second frame, which are not limited herein. For example, an adhesive (such as solid glue, room temperature curing adhesive, double-sided adhesive or the like) may be used to bond the legs and the lens frame of the first frame to those of the second frame, respectively, or the first frame and the second frame may be fixedly connected at several positions with several screws or rivets to bond the two frames together.

Since ordinary paper used in our daily life has characteristics such as hygroscopicity, porosity, softness and the like, if the ordinary paper is used as the material for making the first frame and the second frame, it is likely to produce deformation or damage. Therefore, preferably, in the manufacturing process of the paper material, starch slurry, gum, rosin, and/or ceramic powder may be added into wood pulp so as to improve physical properties of the paper material, weaken the hygroscopicity thereof, and enhance paper strength.

Further, CaCO₃ (calcium carbonate) and/or white clay (i.e., soft and highly plastic clay formed of aluminosilicate mineral after disordered kaolinite is deposited) may also be added into the wood pulp so as to reduce roughness of the paper material, enhance smoothness of the paper material and make the paper material impervious to liquid.

Obviously, other material may also be added into the wood pulp used to make the paper material, as required, so as to improve the properties of the paper material.

Further, on the surface of the first frame (corresponding to a case that the glasses only comprise the first frame and the lenses 14), or the bonded first and second frames (corresponding to a case that the glasses comprise the first frame, the second frame and the lenses 14), a film layer made of a waterproof material such as polyethylene, polypropylene, polyester, aluminum or the like is provided, or a wax film layer is coated. Such configuration may further enhance hydrophobicity of the first frame or the bonded first and second frames made of the paper material, and improve waterproof performance of the glasses.

It should be noted that, in order to degrade reflective performance or light leakage of the paper material, a black coating may be provided on the inner surface (i.e. a surface facing user's face when the glasses are worn) of the first frame or the bonded first and second frames, and obviously a coating in other dark color may be provided.

For the aesthetic purposes, in addition to the coating in black color or other dark color coated on the inner surface of the first frame or the bonded first and second frames, a coating in other color may be coated on the outer surface (i.e., a surface away from user's face when the glasses are worn) of the first frame or the bonded first and second frames, and a logo may be printed on the outer surface of the lens frame of the first frame or the bonded first and second frames.

In the above embodiment, the lenses 14, for example, may be ordinary lenses used for correcting vision, such as myopic or hyperopic lenses, or lenses providing eye protection from various damages, or polarizing lenses used for viewing 3D stereo images.

Preferably, holes or slots (not shown in figures) may be provided in the legs 11 of the first frame (corresponding to the case that the glasses only comprises the first frame and the lenses), or the legs (comprising legs 11 and 12) of the bonded first and second frames (corresponding to the case that the glasses comprises the first frame, the second frame and the lenses). Without doubt, similar to the structure of the existing glasses, the glasses of this embodiment also comprise two legs (referring to the legs of the first frame, or the legs of the bonded first and second frames), and the two legs are respectively at two sides of the lens frame (referring to lens frame 12 or bonded lens frames 12 and 22) and symmetrical to each other. One hole or slot is provided in each of the two legs, for example, one hole or slot may be provided at the end of each of the two legs. The two holes or slots provided in the two legs may be connected by an elastic element, which may be made of rubber band or other elastic material, thus improving fastness of the glasses when they are worn and making the glasses more suitable for children.

### Embodiment 2

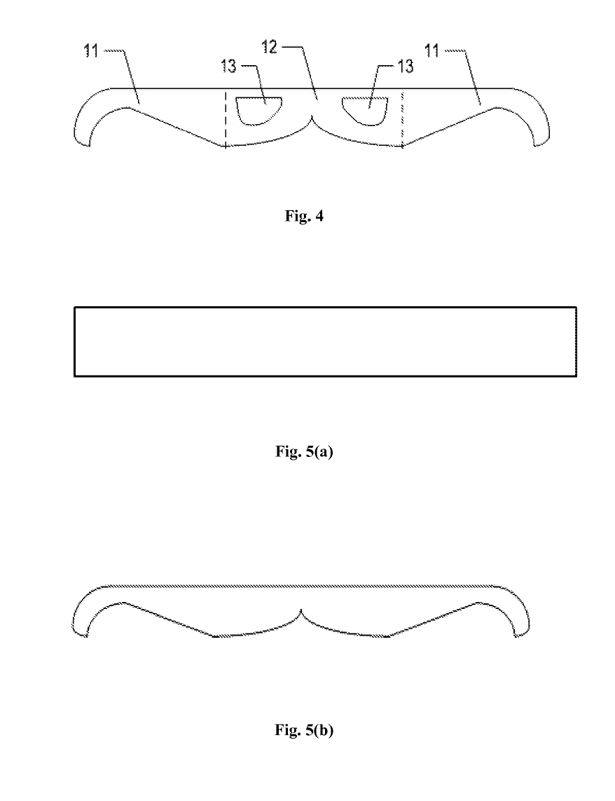

This embodiment provides a manufacturing method of the glasses in the Embodiment 1, which, as shown in FIGS. 4 and 5, comprises the following steps of:

as shown in FIG. 4, selecting a paper material, and integrally forming a first frame including legs 11, a lens frame 12 and lens holes 13 by cutting; and

providing lenses 14 at the lens holes 13.

In this embodiment, the first frame of the glasses is made of a paper material. Since the paper material has soft texture and is easy to cut, the shape of the first frame may be formed manually or by automatic cutting without using a specialized mould to take shape. Thus, the manufacturing process is simple, the cost is low, and the glasses are light in weight, easy to carry and less likely to be fractured.

Preferably, in the above manufacturing method, referring to FIGS. 4, 5(a) and 5(b), the step of selecting a paper material, and integrally forming a first frame including legs 11, a lens frame 12 and lens holes 13 by cutting specifically comprises the following steps.

At step 101, a paper material is selected, and, as shown in FIG. 5(b), a first frame including shapes of legs 11 and the lens frame 12 is formed by cutting.

This step may further comprise: cutting the selected paper material into a rectangular shape shown in FIG. 5(a), wherein the specific size of the rectangle may be set according to the size of the glasses. For example, the selected paper material may be cut into a rectangular shape having a length of about 40 cm and a width of about 5 cm with an error of about 1 cm.

Then, the paper material in the rectangular shape shown in FIG. 5(a) is cut into a shape shown in FIG. 5(b) through a manual or automatic cutting process, so as to form the first frame including shapes of the legs 11 and the lens frame 12.

The specific shape of the first frame is similar to that of the existing glasses, and thus the cutting process may be performed according to the shape of the existing glasses to form the first frame. For example, in this embodiment, the first frame comprises two legs 11 which are respectively at both sides of the lens frame 12 and symmetrical to each other; a width of each leg 11 is 0.5-2 cm, contour of a lower edge of the lens frame 12 is like a herringbone, and two partial areas of the lens frame 12 for forming two lens holes 13 have shapes symmetrical to each other, so the contour of a lower edge of the lens frame 12 also has a symmetrical shape, and an included angle of the symmetrical contour may be an acute angle, an obtuse angle or a rounded corner with a certain radian.

At step 102, the lens holes 13 are formed in the lens frame 12.

On the basis of the above step 101, a hole-cutting operation is performed through a manual or automatic cutting process to form the lens holes 13.

At step 103, areas are distributed for the legs 11 and the lens frame 12 to obtain boundaries 15 between the legs 11 and the lens frame 12, and then a folding operation is performed along boundaries 15 between the legs 11 and the lens frame 12 to form the legs 11 and the lens frame 12.

Referring to FIG. 1, at the step of distributing areas for the legs 11 and the lens frame 12, the following sizes may be adopted: the length of each leg 11 is about 13 cm and the length of the lens frame 12 may be 14 cm. Subsequently, the folding operation is performed along boundaries 15 shown in FIG. 1.

It should be noted that, among the above steps, step 103 may be performed before or after the step of providing the lenses 14 at the lens holes 13, that is, it is possible to provide the lenses 14 at the lens holes 13 before folding along the boundaries 15 between the legs 11 and the lens frame 12; it is also possible to provide the lenses 14 at the lens holes 13 after folding along the boundaries 15 between the legs 11 and the lens frame 12.

Preferably, when the glasses in Embodiment 1 further comprises the second frame, the manufacturing method further comprises a steps of: forming the second frame and bonding the first and second frames to each other, wherein the second frame and the first frame have the same material and shape.

Here, the step of forming the second frame, as shown in FIG. 2, specifically comprises steps of:

selecting a paper material, and forming the second frame including shapes of legs 21 and a lens frame 22 and having the same shape as the first frame by cutting;

forming lens holes 23 having the same shape as those of the first frame in the lens frame 22 of the second frame; and

distributing the same areas for the legs 21 and the lens frame 22 as those distributed in the first frame to obtain boundaries 25 between the legs 21 and the lens frame 22.

After providing the lenses 14 at the lens holes 13, the step of bonding the first frame and the second frame to each other is performed.

In the above process of manufacturing the glasses, areas are distributed for the legs 11 and the lens frame 12 to obtain the boundaries 15 between the legs 11 and the lens frame 12 after forming the first frame including shapes of legs 11 and lens frame 12 by cutting, then the folding operation is performed along the boundaries 15 between the legs 11 and the lens frame 12 to form the legs 11 and the lens frame 12, and further the second frame is manufactured; as for the second frame, areas are distributed for the legs 21 and the lens frame 22 in the same way as above to obtain the boundaries 25 between the legs 21 and the lens frame 22, then the folding operation is performed along the boundaries 25 between the legs 21 and the lens frame 22 to form the legs 21 and the lens frame 22, and finally the first frame and the second frame are bonded together. Alternatively, after the first frame and the second frame are bonded together, areas may be distributed for the bonded legs and lens frames to obtain boundaries between the bonded legs and lens frames, and then the folding operation is performed along the boundaries between the bonded legs and lens frames to form the bonded legs and lens frames.

Further, two pieces of paper material may be firstly selected as the material to form the first frame and the second frame in Embodiment 1, then lens holes 13 and 23 having the same shape are cut in the two pieces of paper material, respectively, after that, the two pieces of paper material are bonded together according to positions of the lens holes 13 and 23 on the two pieces of paper material, while the lenses 14 are sandwiched between the two pieces of paper material and fixed at the lens holes 13 and 23, and finally, the bonded paper material is cut to form the glasses including legs and a lens frame.

Preferably, the paper material may be made by adding starch slurry, gum, rosin, and/or ceramic powder into wood pulp so as to improve properties of the paper material, weaken the hygroscopicity thereof, and enhance paper strength as required. Moreover, calcium carbonate and/or white clay may also be added to the wood pulp so as to reduce roughness of the paper material, enhance smoothness of the paper material and make the paper material impervious to liquid as required.

Further, the manufacturing method further comprises a step of:

on the surfaces of the first frame (corresponding to the case that the glasses only comprise the first frame and the lenses 14) or the bonded first and second frames (corresponding to the case that the glasses comprise the first frame, the second frame and the lenses 14), a film layer made of a waterproof material such as polyethylene, polypropylene, polyester, aluminum or the like is provided.

Preferably, the manufacturing method further comprises a step of: on the inner surface of the first frame or the bonded first and second frames, a coating in black color is formed.

When the glasses in Embodiment 1 are glasses used for viewing 3D stereo images, the manufacturing method further comprises a step of:

forming polarizing lenses which are used for viewing 3D stereo images.

Further, the manufacturing method further comprises a step of:

forming holes or slots (not shown in figures) in the legs 11 of the first frame (corresponding to the case that the glasses only comprise the first frame and the lenses), or the legs (including legs 11 and legs 12) of the bonded first and second frames (corresponding to the case that the glasses comprise the first frame, the second frame and the lenses). Without doubt, similar to the structure of the existing glasses, the glasses manufactured according to this embodiment also comprise two legs (referring to the legs 11 of the first frame, or the legs of bonded first and second frames), and the two legs are respectively at two sides of the lens frame (referring to lens frame 12 or bonded lens frames 12 and 22) and symmetrical to each other. One hole or slot may be formed in each of the two legs, for example, one hole or slot may be formed at the end of each of the two legs. The two holes or slots formed in the two legs may be connected by an elastic element, which may be made of rubber band or other elastic material, thus improving fastness of the glasses when being worn and making the glasses more suitable for children.

It should be further noted that, in the manufacturing method of the glasses in this embodiment, it is possible to, upon completion of layout design of the glasses, perform printing by a printer and perform automatic cutting to form the first frame comprising the legs 11, the lens frame 12 and the lens holes 13, then bond the lenses 14 to the first frame, and afterwards, fold along the boundaries 15 between the legs 11 and the lens frame 12; alternatively, it is also possible to perform printing by a printer and perform automatic cutting to form the first frame comprising the legs 11, the lens frame 12 and the lens holes 13 and the second frame comprising the legs 21, the lens frame 22 and the lens holes 23, then sandwich and bond the lenses 14 between the first and second frame, and afterwards, fold along the boundaries between the bonded legs and lens frames, thus finishing manufacture of the glasses. Obviously, with this method, production efficiency of glasses is improved, and since the glasses may be endowed with colors and patterns designed by a designer, the glasses own a better aesthetic property.

It can be understood that, the above implementations are merely exemplary implementations used for explaining the principle of the present invention, but the present invention is not limited thereto. For those skilled in the art, various modifications and improvements may be made without departing from the spirit and essence of the present invention, and these modifications and improvements are deemed as falling within the protection range of the present invention.

1. Glasses, comprising lenses, wherein, the glasses further comprise a first frame made of a paper material, the first frame comprises legs and a lens frame which are formed integrally, the lens frame is provided with lens holes for viewing, and the lenses are provided at the lens holes.

2. The glasses according to claim 1, wherein, the glasses further comprise a second frame which has the same material and shape as the first frame and is bonded to the first frame; and
the lenses are sandwiched between the first frame and the second frame.

3. The glasses according to claim 1, wherein, the paper material is made by adding starch slurry, gum, rosin, ceramic powder, calcium carbonate and/or white clay into wood pulp

4. The glasses according to claim 2, wherein, on surfaces of the bonded first and second frames, a film layer formed of polyethylene, polypropylene, polyester or aluminum is provided, or a wax film layer is coated.

5. The glasses according to claim 2, wherein, on an inner surface of the bonded first and second frames, a coating in black color or other dark color is provided.

6. The glasses according to claim 1, wherein, the lenses are polarizing lenses which are used for viewing 3D stereo images.

7. The glasses according to claim 1, wherein, holes or slots are provided in the legs.

8. A manufacturing method of the glasses according to claim 1, comprising steps of:
selecting a paper material, and integrally forming a first frame including legs, a lens frame and lens holes by cutting; and
providing lenses at the lens holes.

9. The manufacturing method of the glasses according to claim 8, wherein, the step of selecting a paper material, and integrally forming a first frame including legs, a lens frame and lens holes by cutting specifically comprises steps of:
selecting the paper material, and forming the first frame including shapes of the legs and the lens frame by cutting;
forming the lens holes in the lens frame; and
distributing areas for the legs and the lens frame to obtain boundaries between the legs and the lens frame, then folding along the boundaries between the legs and the lens frame to form the legs and the lens frame.

10. The manufacturing method of the glasses according to claim 9, further comprising steps of: forming a second frame; and bonding the first and second frames to each other.

11. The manufacturing method of the glasses according to claim 10, wherein, the step of forming a second frame comprises steps of:
selecting a paper material, and forming the second frame including shapes of legs and a lens frame by cutting, the second frame having the same shape as the first frame;
forming lens holes having the same shape as the lens holes of the first frame in the lens frame of the second frame; and
distributing the same areas for the legs and the lens frame of the second frame as those distributed in the first frame to obtain boundaries between the legs and the lens frame; and
after providing the lenses at the lens holes of the first frame or the second frame, the step of bonding the first and second frames to each other is performed.

12. The manufacturing method of the glasses according to claim 10, further comprising a step of:
on surfaces of the bonded first and second frames, forming a film layer formed of polyethylene, polypropylene, polyester or aluminum, or forming a wax film layer.

13. The manufacturing method of the glasses according to claim 10, further comprising a step of:
forming a coating in black color or other dark color on an inner surface of the bonded first and second frames.

14. The manufacturing method of the glasses according to claim 8, further comprising a step of:
forming polarizing lenses which are used for viewing 3D stereo images.

15. The manufacturing method of the glasses according to claim 8, further comprising a step of:
forming holes or slots in the legs.
